(19) United States
(12) Patent Application Publication
(10) Pub. No.: US 2023/0086398 A1
(43) Pub. Date: Mar. 23, 2023

(54) MASTER CELL GROUP (MCG) FAILURE AND RADIO LINK FAILURE (RLF) REPORTING

(71) Applicant: Telefonaktiebolaget LM Ericsson (publ), Stockholm (SE)

(72) Inventors: Oumer TEYEB, Montréal (CA); Pradeepa RAMACHANDRA, Linköping (SE)

(73) Assignee: Telefonaktiebolaget LM Ericsson (publ), Stockholm (SE)

(21) Appl. No.: 17/908,791

(22) PCT Filed: Feb. 26, 2021
(86) PCT No.: PCT/EP2021/054949

§ 371 Date: Sep. 1, 2022

Related U.S. Application Data
(60) Provisional application No. 62/984,084, filed on Mar. 2, 2020.

(51) Int. Cl. H04W 36/30; H04W 76/19

(52) U.S. Cl. CPC H04W 36/305; H04W 76/19; H04W 84/12

(57) ABSTRACT

A method (400) for providing radio link failure (RLF) information. The method includes a UE (302) detecting (s402) an RLF with respect to a master cell group (MCG). The method also includes, in response to detecting the RLF with respect to the MCG, the UE either storing an RLF report and initiating a fast MCG link recovery procedure (s404) or transmitting an enhanced MCG failure information message as part of the fast MCG link recovery procedure.

### TECHNICAL FIELD

Disclosed are embodiments related to MCG failure reporting and RLF failure reporting.

### BACKGROUND

1.1-5G Architecture

The current 5G Radio Access Network (RAN) (Next-Generation RAN) architecture is depicted and described in Technical Specification (TS) 38.401v15.7.0 (www.3gpp.org/ftp//Specs/archive/38_series/38.401/38401-f70.zip) as shown in FIG. 1.

The NG architecture can be further described as follows. The NG-RAN consists of a set of next generation base stations (gNBs) connected to the 5G core (5GC) through the next-generation (NG) interface. A gNB can support frequency division duplex (FDD) mode, time division duplex (TDD) mode or dual mode operation. gNBs can be interconnected through the Xn interface. A gNB may consist of a gNB central unit (gNB-CU) and one or more gNB distributed units (gNB-DU). A gNB-CU and a gNB-DU are connected via F1 logical interface. One gNB-DU is connected to only one gNB-CU. For resiliency, a gNB-DU may be connected to multiple gNB-CU by appropriate implementation. NG, Xn and F1 are logical interfaces. The NG-RAN is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and signaling transport.

Another architectural option is that where an Long Term Evolution (LTE) evolved NodeB (eNB) connected to the Evolved Packet Core network is connected over the X2 interface with a so called NR-gNB. The latter is a gNB not connected directly to a core network (CN) and connected via X2 to an eNB for the sole purpose of performing dual connectivity.

The architecture in FIG. 1 can be expanded by spitting the gNB-CU into two entities. One gNB-CU-User Plane (gNB-CU-UP), which serves the user plane and hosts the packet data convergence protocol (PDCP) protocol and one gNB-CU-CP, which serves the control plane and hosts the PDCP and radio resource control (RRC) protocol. For completeness it should be said that a gNB-DU hosts the radio link control (RLC)/medium access control (MAC)/physical layer (PHY) protocols.

1.2—Mobility Robustness Organization (MRO) and Radio Link Failure (RLF) in LTE/NR

Seamless handovers are a key feature of 3rd Generation Partnership Project (3GPP) technologies. Successful handovers ensure that a user equipment (UE) (i.e., any device capable of wireless communication with an access point (e.g. gNB, eNB, etc.) moves around in the coverage area of different cells without causing too much interruptions in the data transmission. However, there will be scenarios when the network fails to handover the UE to the ‘correct’ neighbor cell in time and in such scenarios the UE will declare the radio link failure (RLF) or Handover Failure (HOF).

Upon HOF and RLF, the UE may take autonomous actions i.e. trying to select a cell and initiate reestablishment procedure so that we make sure the UE is trying to get back as soon as it can, so that it can be reachable again. The RLF will cause a poor user experience as the RLF is declared by the UE only when it realizes that there is no reliable communication channel (radio link) available between itself and the network. Also, reestablishing the connection requires signaling with the newly selected cell (random access procedure, RRC Reestablishment Request, RRC Reestablishment RRC Reestablishment Complete, RRC Reconfiguration and RRC Reconfiguration Complete) and adds some latency, until the UE can exchange data with the network again.

According to the LTE/NR specifications (TS 36.331, TS 38.331), the possible causes for the radio link failure could be one of the following:

1) expiry of the radio link monitoring related timer T310;

2) expiry of the measurement reporting associated timer T312 (not receiving the handover command from the network within this timer's duration despite sending the measurement report when T310 was running);

3) upon reaching the maximum number of RLC retransmissions for the MCG; and

4) upon receiving random access problem indication from the MCG MAC entity.

As RLF leads to reestablishment which degrades performance and user experience, it is in the interest of the network to understand the reasons for RLF and try to optimize mobility related parameters (e.g. trigger conditions of measurement reports) to avoid later RLFs. Before the standardization of MRO related report handling in the network, only the UE was aware of some information associated to how did the radio quality looked like at the time of RLF, what is the actual reason for declaring RLF etc. For the network to identify the reason for the RLF, the network needs more information, both from the UE and also from the neighboring base stations.

As part of the MRO solution in LTE, the RLF reporting procedure was introduced in the RRC specification in Rel-9 RAN2 work. That has impacted the RRC specifications (TS 36.331) in the sense that it was standardized that the UE would log relevant information at the moment of an RLF and later report to a target cell the UE succeeds to connect (e.g. after reestablishment). That has also impacted the inter-gNodeB interface, i.e., X2AP specifications (TS 36.423), as an eNB receiving an RLF report could forward to the eNB where the failure has been originated.

In LTE/NR, lower layers provide to upper layer Out-of-Sync (OOS) and In-Sync (IS), internally by the UE's physical layer, which in turn may apply RRC/layer 3 (i.e. higher layer) filtering for the evaluation of Radio Link Failure (RLF). The procedure is illustrated in FIG. 2. FIG. 2 shows higher layer RLF related procedures in LTE.

For the RLF report generated by the UE, its contents have been enhanced with more details in the subsequent releases. The measurements included in the measurement report based on the latest LTE RRC specification (3GPP TS 36.331 V12.8.0) are:
1) Measurement quantities (e.g., Reference Signal Received Power (RSRP) and Reference Signal Received Quality (RSRQ)) of the last serving cell (PCell).
2) Measurement quantities of the neighbor cells in different frequencies of different RATs (Universal Terrestrial Radio Access (UTRA), Evolved-UTRA (E-UTRA), Global System for Mobile Communications (GSM) Edge RAN (GERAN), Code-Division Multiple Access (CDMA) 2000).
3) Measurement quantity (Received Signal Strength Indicator (RSSI)) associated to Wireless Local Area Network (WLAN) Aps.
4) Measurement quantity (RSSI) associated to Bluetooth beacons.
5) Location information, if available (including location coordinates and velocity)
6) Globally unique identity of the last serving cell, if available, otherwise the physical cell ID (PCI) and the carrier frequency of the last serving cell.
7) Tracking area code of the PCell.
8) Time elapsed since the last reception of the ‘Handover command’ message.
9) Cell Radio Network Temporary Identifier (C-RNTI) used in the previous serving cell.
10) Whether or not the UE was configured with a data radio bearer (DRB) having Quality of Service (QoS) Class Identifier (QCI) value of 1.

The detection and logging of the RLF related parameters is captured in section 5.3.11.3 of LTE RRC specification, which is reproduced in the table below.

5.3.11.3 Detection of radio link failure

The UE shall:

| | 1> | upon T310 expiry; or | | | | |
|---|---|---|---|---|---|---|
| | 1> | upon T312 expiry; or | | | | |
| | 1> | upon random access problem indication from MCG MAC while neither T300, T301, | | | | |
| | | T304 nor T311 is running; or | | | | |
| | 1> | upon indication from MCG RLC, which is allowed to be send on PCell, that the | | | | |
| | | maximum number of retransmissions has been reached for an SRB or DRB: | | | | |
| | | 2> | consider radio link failure to be detected for the MCG i.e. RLF; | | | |
| | | 2> | except for NB-IoT, store the following radio link failure information in the VarRLF- | | | |
| | | | Report by setting its fields as follows: | | | |
| | | | 3> | clear the information included in VarRLF-Report, if any; | | |
| | | | 3> | set the plmn-IdentityList to include the list of EPLMNs stored by the UE (i.e. | | |
| | | | | includes the RPLMN); | | |
| | | | 3> | set the measResultLastServCell to include the RSRP and RSRQ, if available, of the | | |
| | | | | PCell based on measurements collected up to the moment the UE detected radio | | |
| | | | | link failure; | | |
| | | | 3> | set the measResultNeighCells to include the best measured cells, other than the | | |
| | | | | PCell, ordered such that the best cell is listed first, and based on measurements | | |
| | | | | collected up to the moment the UE detected radio link failure, and set its fields as | | |
| | | | | follows; | | |
| | | | | 4> | if the UE was configured to perform measurements for one or more EUTRA | |
| | | | | | frequencies, include the measResultListEUTRA; | |
| | | | | 4> | if the UE was configured to perform measurement reporting for one or more | |
| | | | | | neighbouring UTRA frequencies, include the measResultListUTRA; | |
| | | | | 4> | if the UE was configured to perform measurement reporting for one or more | |
| | | | | | neighbouring GERAN frequencies, include the measResultListGERAN; | |
| | | | | 4> | if the UE was configured to perform measurement reporting for one or more | |
| | | | | | neighbouring CDMA2000 frequencies, include the measResultsCDMA2000; | |
| | | | | 4> | for each neighbour cell included, include the optional fields that are available; | |
| NOTE 1: | | | | The measured quantities are filtered by the L3 filter as configured in the mobility | | |
| | | | | measurement configuration. The measurements are based on the time domain | | |
| | | | | measurement resource restriction, if configured. Blacklisted cells are not required | | |
| | | | | to be reported. | | |
| | | | 3> | if available, set the logMeasResultlistWLAN to include the WLAN measurement | | |
| | | | | results, in order of decreasing RSSI for WLAN APs; | | |
| | | | 3> | if available, set the logMeasResultListBT to include the Bluetooth measurement | | |
| | | | | results, in order of decreasing RSSI for Bluetooth beacons; | | |
| | | | 3> | if detailed location information is available, set the content of the locationinfo as | | |
| | | | | follows: | | |
| | | | | 4> | include the locationCoordinates; | |
| | | | | 4> | include the horizontalVelocity, if available; | |
| | | | 3> | set the failedPCellId to the global cell identity, if available, and otherwise to the | | |
| | | | | physical cell identity and carrier frequency of the PCell where radio link failure is | | |
| | | | | detected; | | |
| | | | 3> | set the tac-FailedPCell to the tracking area code, if available, of the PCell where | | |
| | | | | radio link failure is detected; | | |
| | | | 3> | if an RRCConnectionReconfiguration message including the mobilityControlInfo | | |
| | | | | was received before the connection failure: | | |
| | | | | 4> | if the last RRCConnectionReconfiguration message including the | |
| | | | | | mobilityControlInfo concerned an intra E-UTRA handover: | |
| | | | | | a | 5> include the previousPCellId and set it to the global cell identity |
| | | | | | | of the PCell where the last RRCConnectionReconfiguration message |
| | | | | | | including mobilityControlInfo was received; |
| | | | | | b | 5> set the timeConnFailure to the elapsed time since reception of |
| | | | | | | the last RRCConnectionReconfiguration message including the |
| | | | | | | mobilityControlInfo; |
| | | | | 4> | if the last RRCConnectionReconfiguration message including the | |
| | | | | | mobilityControlInfo concerned a handover to E-UTRA from UTRA and if the | |
| | | | | | UE supports Radio Link Failure Report for Inter-RAT MRO: | |
| | | | | | c | 5> include the previousUTRA-CellId and set it to the physical cell |
| | | | | | | identity, the carrier frequency and the global cell identity, if available, of the |
| | | | | | | UTRA Cell in which the last RRCConnectionReconfiguration message |
| | | | | | | including mobilityControlInfo was received; |
| | | | | | d | 5> set the timeConnFailure to the elapsed time since reception of |
| | | | | | | the last RRCConnectionReconfiguration message including the |
| | | | | | | mobilityControlInfo; |
| | | | 3> | if the UE supports QCI1 indication in Radio Link Failure Report and has a DRB | | |
| | | | | for which QCI is 1: | | |
| | | | | 4> | include the drb-EstablishedWithQCI-1; | |
| | | | 3> | set the connectionFailureType to rlf | | |
| | | | 3> | set the c-RNTI to the C-RNTI used in the PCell; | | |
| | | | 3> | set the rlf-Cause to the trigger for detecting radio link failure; | | |
| | | 2> | if AS security has not been activated: | | | |
| | | | 3> | if the UE is a NB-IoT UE: | | |
| | | | | 4> | if the UE supports RRC connection re-establishment for the Control Plane CIoT | |
| | | | | | EPS optimisation: | |
| | | | | | e | 5> initiate the RRC connection re-establishment procedure as |
| | | | | | | specified in 5.3.7; |
| | | | | 4> | else: | |
| | | | | | f | 5> perform the actions upon leaving RRC_CONNECTED as |
| | | | | | | specified in 5.3.12, with release cause ‘RRC connection failure’; |

| 3> | else: | |
|---|---|---|
| | 4> | perform the actions upon leaving RRC_CONNECTED as specified in 5.3.12, |
| | | with release cause ‘other’; |

| 2> | else: | |
|---|---|---|
| | 3> | initiate the connection re-establishment procedure as specified in 5.3.7; |

In case of DC, the UE shall:

| 1> | upon T313 expiry; or | |
|---|---|---|
| 1> | upon random access problem indication from SCG MAC; or | |
| 1> | upon indication from SCG RLC, which is allowed to be sent on PSCell, that the | |
| | maximum number of retransmissions has been reached for an SCG or split DRB: | |
| | 2> | consider radio link failure to be detected for the SCG i.e. SCG-RLF; |
| | 2> | initiate the SCG failure information procedure as specified in 5.6.13 to report SCG |
| | | radio link failure; |

In case of CA PDCP duplication, the UE shall:

| 1> | upon indication from an RLC entity, which is restricted to be sent on SCell only, that the | |
|---|---|---|
| | maximum number of retransmissions has been reached: | |
| | 2> | consider radio link failure to be detected for the RLC entity; |
| | 2> | initiate the failure information procedure as specified in 5.6.21 to report PDCP |
| | | duplication failure; |

The UE may discard the radio link failure information, i.e. release the UE variable VarRLF-
Report, 48 hours after the radio link failure is detected, upon power off or upon detach.

After the RLF is declared, the RLF report is logged and, once the UE selects a cell and succeeds with a reestablishment, it includes an indication that it has an RLF report available in the RRC Reestablishment Complete message, to make the target cell aware of that availability. Then, upon receiving an UEInformationRequest message with a flag “rlf-ReportReq-r9” the UE shall include the RLF report (stored in a UE variable VarRLF-Report, as described above) in an UEInformationResponse message and send to the network.

The UEInformationRequest and UEInformationResponse messages are described below.

UEInformationRequest—The UEInformationRequest is the command used by E-UTRAN to retrieve information from the UE. The signaling radio bearer for the message is SRB1; the RLC-SAP is AM; the Logical channel is DCCH, and the direction is E-UTRAN to UE.

The below table illustrates various UEInformationRequest messages:

| -- ASN1START | | |
|---|---|---|
| UEInformationRequest-r9 ::= SEQUENCE { | | |
| rrc-TransactionIdentifier RRC-TransactionIdentifier, | | |
| criticalExtensions CHOICE { | | |
| c1 CHOICE { | | |
| ueInformationRequest-r9 UEInformationRequest-r9-IEs, | | |
| spare3 NULL, spare2 NULL, spare1 NULL | | |
| }, | | |
| criticalExtensionsFuture SEQUENCE { } | | |
| } | | |
| } | | |
| UEInformationRequest-r9-IEs ::= | SEQUENCE{ | |
| rach-ReportReq-r9 | BOOLEAN, | |
| rlf-ReportReq-r9 | BOOLEAN, | |
| nonCriticalExtension | UEInformationRequest-v930-IEs | OPTIONAL |
| } | | |
| UEInformationRequest-v930-IEs ::= SEQUENCE { | | |
| lateNonCriticalExtension | OCTET STRING | OPTIONAL, |
| nonCriticalExtension | UEInformationRequest-v1020-IEs | OPTIONAL |
| } | | |
| UEInformationRequest-v1020-IEs := | SEQUENCE { | |
| logMeasReportReq-r10 | ENUMERATED {true} | |
| OPTIONAL, -- Need ON | | |
| nonCriticalExtension | UEInformationRequest-v1130-IEs | OPTIONAL |
| } | | |
| UEInformationRequest-v1130-IEs := SEQUENCE { | | |
| connEstFailReportReq-r11 | ENUMERATED {true} | |
| OPTIONAL, -- Need ON | | |
| nonCriticalExtension | UEInformationRequest-v1250-IEs | OPTIONAL |
| } | | |
| UEInformationRequest-v1250-IEs := SEQUENCE { | | |
| mobilityHistoryReportReq-r12 | ENUMERATED {true} | |
| OPTIONAL, -- Need ON | | |
| nonCriticalExtension | UEInformationRequest-v1530-IEs | OPTIONAL |
| } | | |
| UEInformationRequest-v1530-IEs ::= SEQUENCE { | | |
| idleModeMeasurementReq-r15 | ENUMERATED {true} | |
| OPTIONAL, -- Need ON | | |
| flightPathInfoReq-r15 | FlightPathInfoReportConfig-r15 | OPTIONAL, |
| -- Need ON | | |
| nonCriticalExtension | SEQUENCE { } | |
| OPTIONAL | | |
| } | | |
| -- ASNISTOP | | |

UEInformationRequest field descriptions—rach-ReportReq: This field is used to indicate whether the UE shall report information about the random access procedure.

UEInformationResponse

The UEInformationResponse message is used by the UE to transfer the information requested by the E-UTRAN. The signaling radio bearer for the UEInformationResponse is SRB1 or SRB2 (when logged measurement information is included); the RLC-SAP is AM; the Logical channel is DCCH; and the direction is UE to E-UTRAN.

The table below illustrates various UEInformationResponse messages.

```
-- ASN1START
UEInformationResponse-r9::= SEQUENCE {
    rrc-TransactionIdentifier RRC-TransactionIdentifier,
    criticalExtensions CHOICE {
        c1  CHOICE {
            ueInformationResponse-r9 UEInformationResponse-r9-IEs,
            spare3 NULL, spare2 NULL, spare1 NULL
        },
        criticalExtensionsFuture SEQUENCE { }
    }
}
UEInformationResponse-r9-IEs ::=  SEQUENCE {
    rach-Report-r9 SEQUENCE {
        numberOfPreamblesSent-r9 NumberOfPreamblesSent-r11,
        contentionDetected-r9 BOOLEAN
    } OPTIONAL,
    rlf-Report-r9 RLF-Report-r9 OPTIONAL,
    nonCriticalExtension  UEInformationResponse-v930-IEs
    OPTIONAL
}
-- Late non critical extensions =
UEInformationResponse-v9e0-IEs ::= SEQUENCE {
    rlf-Report-v9e0  RLF-Report-v9e0 OPTIONAL,
    nonCriticalExtension SEQUENCE { }  OPTIONAL
}
-- Regular non critical extensions
UEInformationResponse-v930-IEs ::= SEQUENCE {
    lateNonCriticalExtension OCTET STRING (CONTAINING
UEInformationResponse-v9e0-IEs) OPTIONAL,
    nonCriticalExtension UEInformationResponse-v1020-IEs
    OPTIONAL
}
UEInformationResponse-v1020-IEs ::= SEQUENCE {
    logMeasReport-r10  LogMeasReport-r10  OPTIONAL,
    nonCriticalExtension  UEInformationResponse-v1130-IEs
    OPTIONAL
}
UEInformationResponse-v1130-IEs ::= SEQUENCE {
    connEstFailReport-r11  ConnEstFailReport-r11  OPTIONAL,
    nonCriticalExtension  UEInformationResponse-v1250-IEs  OPTIONAL
}
UEInformationResponse-v1250-IEs ::= SEQUENCE {
    mobilityHistoryReport-r12  MobilityHistoryReport-r12 OPTIONAL,
    nonCriticalExtension  UEInformationResponse-v1530-IEs  OPTIONAL
}
UEInformationResponse-v1530-IEs ::= SEQUENCE {
    measResultListIdle-r15  MeasResultListIdle-r15 OPTIONAL,
    flightPathInfoReport-r15  FlightPathInfoReport-r15  OPTIONAL,
    nonCriticalExtension  SEQUENCE { }  OPTIONAL
}
RLF-Report-r9 ::=  SEQUENCE {
    measResultLastServCell-r9 SEQUENCE {
        rsrpResult-r9 RSRP-Range,
        rsrqResult-r9 RSRQ-Range OPTIONAL
    },
    measResultNeighCells-r9  SEQUENCE {
        measResultListEUTRA-r9  MeasResultList2EUTRA-r9
    OPTIONAL,
        measResultListUTRA-r9  MeasResultList2UTRA-r9
    OPTIONAL,
        measResultListGERAN-r9  MeasResultListGERAN
    OPTIONAL,
        measResultsCDMA2000-r9  MeasResultList2CDMA2000-r9
    OPTIONAL
    }  OPTIONAL,
    ...,
    [[  locationInfo-r10  LocationInfo-r10  OPTIONAL,
        failedPCellId-r10  CHOICE {
            cellGlobalId-r10  CellGlobalIdEUTRA,
            pci-arfcn-r10  SEQUENCE {
                physCellId-r10  PhysCellId,
                carrierFreq-r10 ARFCN-ValueEUTRA
            }
        }  OPTIONAL,
        reestablishmentCellId-r10  CellGlobalIdEUTRA OPTIONAL,
        timeConnFailure-r10  INTEGER (0..1023) OPTIONAL,
        connectionFailureType-r10  ENUMERATED {rlf, hof} OPTIONAL,
        previousPCellId-r10  CellGlobalIdEUTRA OPTIONAL
    ]],
    [[  failedPCellId-v1090  SEQUENCE {
          carrierFreq-v1090  ARFCN-ValueEUTRA-v9e0
        }  OPTIONAL
    ]],
    [[  basicFields-r11  SEQUENCE {
          c-RNTI-r11  C-RNTI,
          rlf-Cause-r11  ENUMERATED {
                                        t310-Expiry, randomAccessProblem,
                                        rlc-MaxNumRetx, t312-Expiry-r12},
          timeSinceFailure-r11 TimeSinceFailure-r11
        } OPTIONAL,
        previousUTRA-CellId-r11  SEQUENCE {
          carrierFreq-r11  ARFCN-ValueUTRA,
          physCellId-r11  CHOICE {
              fdd-r11  PhysCellIdUTRA-FDD,
              tdd-r11  PhysCellIdUTRA-TDD
          },
          cellGlobalId-r11  CellGlobalIdUTRA OPTIONAL
        } OPTIONAL,
        selectedUTRA-CellId-r11  SEQUENCE {
          carrierFreq-r11  ARFCN-ValueUTRA,
          physCellId-r11 CHOICE {
              fdd-r11 PhysCellIdUTRA-FDD,
              tdd-r11 PhysCellIdUTRA-TDD
          }
        } OPTIONAL
    ]],
    [[  failedPCellId-v1250 SEQUENCE {
          tac-FailedPCell-r12 TrackingAreaCode
        } OPTIONAL,
        measResultLastServCell-v1250RSRQ-Range-v1250 OPTIONAL,
        lastServCellRSRQ-Type-r12 RSRQ-Type-r12 OPTIONAL,
        measResultListEUTRA-v1250 MeasResultList2EUTRA-v1250
    OPTIONAL
    ]],
    [[  drb-EstablishedWithQCI-1-r13 ENUMERATED {qci1}
    OPTIONAL
    ]],
    [[  measResultLastServCell-v1360 RSRP-Range-v1360
    OPTIONAL
    ]],
    [[  logMeasResultListBT-r15 LogMeasResultListBT-r15  OPTIONAL,
        logMeasResultListWLAN-r15 LogMeasResultListWLAN-r15  OPTIONAL
    ]]
}
RLF-Report-v9e0 ::=  SEQUENCE {
    measResultListEUTRA-v9e0 MeasResultList2EUTRA-v9e0
}
MeasResultList2EUTRA-r9 ::= SEQUENCE (SIZE (1..maxFreq)) OF
MeasResult2EUTRA-r9
MeasResultList2EUTRA-v9e0 ::= SEQUENCE (SIZE (1..maxFreq)) OF
MeasResult2EUTRA-v9e0
MeasResultList2EUTRA-v1250 ::= SEQUENCE (SIZE (1..maxFreq)) OF
MeasResult2EUTRA-v1250
MeasResult2EUTRA-r9 ::= SEQUENCE {
    carrierFreq-r9 ARFCN-ValueEUTRA,
    measResultList-r9 MeasResultListEUTRA
}
MeasResult2EUTRA-v9e0 ::=  SEQUENCE {
    carrierFreq-v9e0 ARFCN-ValueEUTRA-v9e0 OPTIONAL
}
MeasResult2EUTRA-v1250 ::=  SEQUENCE {
    rsrq-Type-r12  RSRQ-Type-r12 OPTIONAL
}
MeasResultList2UTRA-r9 ::=  SEQUENCE (SIZE (1..maxFreq)) OF
MeasResult2UTRA-r9
MeasResult2UTRA-r9 ::=  SEQUENCE {
    carrierFreq-r9  ARFCN-ValueUTRA,
    measResultList-r9  MeasResultListUTRA
}
MeasResultList2CDMA2000-r9 ::=  SEQUENCE (SIZE (1..maxFreq)) OF
MeasResult2CDMA2000-r9
MeasResult2CDMA2000-r9 ::=  SEQUENCE {
    carrierFreq-r9  CarrierFreqCDMA2000,
    measResultList-r9  MeasResultsCDMA2000
}
LogMeasReport-r10 ::=  SEQUENCE {
    absoluteTimeStamp-r10 AbsoluteTimeInfo-r10,
    traceReference-r10 TraceReference-r10,
    traceRecordingSessionRef-r10 OCTET STRING (SIZE (2)),
    tce-Id-r10 OCTET STRING (SIZE (1)),
    logMeasInfoList-r10 LogMeasInfoList-r10,
    logMeasAvailable-r10 ENUMERATED {true} OPTIONAL,
    ...,
    [[ logMeasAvailableBT-r15 ENUMERATED {true}
    OPTIONAL,
        logMeasAvailableWLAN-r15 ENUMERATED {true}
    OPTIONAL
    ]]
}
LogMeasInfoList-r10 ::=  SEQUENCE (SIZE (1..maxLogMeasReport-r10)) OF
LogMeasInfo-r10
LogMeasInfo-r10 :: =  SEQUENCE {
    locationInfo-r10  LocationInfo-r10 OPTIONAL,
    relativeTimeStamp-r10 INTEGER (0..7200),
    servCellIdentity-r10 CellGlobalIdEUTRA,
    measResultServCell-r10 SEQUENCE {
        rsrpResult-r10  RSRP-Range,
        rsrqResult-r10 RSRQ-Range
    },
    measResultNeighCells-r10 SEQUENCE {
        measResultListEUTRA-r10 MeasResultList2EUTRA-r9
    OPTIONAL,
        measResultListUTRA-r10 MeasResultList2UTRA-r9 OPTIONAL,
        measResultListGERAN-r10 MeasResultList2GERAN-r10
    OPTIONAL,
        measResultListCDMA2000-r10 MeasResultList2CDMA2000-r9
    OPTIONAL
    } OPTIONAL,
    ...}
    [[ measResultListEUTRA-v1090  MeasResultList2EUTRA-v9e0 OPTIONAL
    ]],
    [[ MeasResultListMBSFN-r12 MeasResultListMBSFN-r12
    OPTIONAL,
        measResultServCell-v1250  RSRQ-Range-v1250 OPTIONAL,
        servCellRSRQ-Type-r12  RSRQ-Type-r12 OPTIONAL,
        measResultServCell-v1250  MeasResultList2EUTRA-v1250
    OPTIONAL
    ]],
    [[ inDeviceCoexDetected-r13  ENUMERATED {true} OPTIONAL
    ]],
    [[ measResultServCell-v1360  RSRP-Range-v1360 OPTIONAL
    ]],
    [[ LogMeasResultListBT-r15  LogMeasResultListBT-r15 OPTIONAL,
      LogMeasResultListWLAN-r15 LogMeasResultListWLAN-r15
    OPTIONAL
    ]]
}
MeasResultListMBSFN-r12  SEQUENCE (SIZE (1..maxMB SFN-Area)) OF
MeasResultMBSFN-r12
MeasResultMBSFN-r12 ::=  SEQUENCE {
    mbsfn-Area-r12  SEQUENCE {
        mbsfn-AreaId-r12  MBSFN-AreaId-r12,
        carrierFreq-r12 ARFCN-ValueEUTRA-r9
    },
    rsrpResultMBSFN-r12  RSRP-Range,
    rsrqResultMBSFN-r12  MBSFN-RSRQ-Range-r12,
    signallingBLER-Result-r12 BLER-Result-r12 OPTIONAL,
    dataBLER-MCH-ResultList-r12 DataBLER-MCH-ResultList-r12
    OPTIONAL,
    ...
}
DataBLER-MCH-ResultList-r12 ::=  SEQUENCE (SIZE (1.. maxPMCH-
PerMBSFN)) OF DataBLER-MCH-Result-r12
DataBLER-MCH-Result-r12 ::=  SEQUENCE {
    mch-Index-r12  INTEGER (1..maxPMCH-PerMBSFN),
    dataBLER-Result-r12  BLER-Result-r12
}
BLER-Result-r12 ::=  SEQUENCE {
    bler-r12  BLER-Range-r12,
    blocksReceived-r12  SEQUENCE {
        n-r12  BIT STRING (SIZE (3)),
        m-r12  BIT STRING (SIZE (8))
    }
}
BLER-Range-r12 ::=  INTEGER(0..31)
MeasResultList2GERAN-r10 ::=  SEQUENCE (SIZE (1..maxCellListGERAN)) OF
MeasResultListGERAN
ConnEstFailReport-r11 ::=  SEQUENCE {
    failedCellId-r11  CellGlobalIdEUTRA,
    locationInfo-r11  LocationInfo-r10 OPTIONAL,
    measResultFailedCell-r11  SEQUENCE {
        rsrpResult-r11  RSRP-Range,
        rsrqResult-r11  RSRQ-Range OPTIONAL
    },
    measResultNeighCells-r11  SEQUENCE {
        measResultListEUTRA-r11  MeasResultList2EUTRA-r9
    OPTIONAL,
      measResultListUTRA-r11  MeasResultList2UTRA-r9
    OPTIONAL,
        measResultListGERAN-r11  MeasResultListGERAN
    OPTIONAL,
        measResultsCDMA2000-r11  MeasResultList2CDMA2000-r9
    OPTIONAL
    } OPTIONAL,
    numberOfPreamblesSent-r11 NumberOfPreamblesSent-r11,
    contentionDetected-r11  BOOLEAN,
    maxTxPowerReached-r11  BOOLEAN,
    timeSinceFailure-r11  TimeSinceFailure-r11,
    measResultListEUTRA-v1130  MeasResultList2EUTRA-v9e0  OPTIONAL,
    ...,
    [[ measResultFailedCell-v1250 RSRQ-Range-v1250 OPTIONAL,
        failedCellRSRQ-Type-r12  RSRQ-Type-r12 OPTIONAL,
        measResultListEUTRA-v1250  MeasResultList2EUTRA-v1250
    OPTIONAL
    ]],
    [[ measResultFailedCell-v1360 RSRP-Range-v1360 OPTIONAL
    ]],
    [[ logMeasResultListBT-r15  LogMeasResultListBT-r15 OPTIONAL,
      logMeasResultListWLAN-r15  LogMeasResultListWLAN-r15  OPTIONAL
    ]]
}
NumberOfPreamblesSent-r11 ::= INTEGER (1..200)
TimeSinceFailure-r11 ::=  INTEGER (0..172800)
MobilityHistoryReport-r12 ::= VisitedCellInfoList-r12
FlightPathInfoReport-r15 ::=  SEQUENCE {
    flightPath-r15  SEQUENCE (SIZE (1..maxWayPoint-r15)) OF WayPointLocation-r15
    OPTIONAL,
    nonCriticalExtension SEQUENCE { }
    OPTIONAL
}
WayPointLocation-r15 ::=  SEQUENCE {
    wayPointLocation-r15 LocationInfo-r10,
    timeStamp-r15 AbsoluteTimeInfo-r10 OPTIONAL
}
-- ASN1STOP
```

Based on the contents of the RLF report (e.g. the Globally unique identity of the last serving cell, where the failure was originated), the cell in which the UE reestablishes can forward the RLF report to the last serving cell. This forwarding of the RLF report is done to aid the original serving cell with tuning of the handover related parameters (e.g. measurement report triggering thresholds) as the original serving cell was the one who had configured the parameters associated to the UE that led to the RLF.

Two different types of inter-node messages have been standardized in LTE for that purpose, the Radio link failure indication and the handover report (in 36.423 REFERENCE).

The Radio link failure indication procedure is used to transfer information regarding RRC re-establishment attempts or received RLF reports between eNBs. This message is sent from the eNB in which the UE performs reestablishment to the eNB which was the previous serving cell of the UE.

1.3 MCG Fast Recovery Procedure

In LTE/NR rel-16, the fast MCG link recovery procedure was agreed. Fast MCG link recovery is an RRC procedure where the UE sends an MCG Failure Information message to the Master Node (MN) via the Secondary Cell Group (SCG) upon the detection of a radio link failure on the MCG, instead of triggering RRC re-establishment.

If radio link failure is detected for MCG, and fast MCG link recovery is configured, the UE triggers fast MCG link recovery. Otherwise, the UE initiates the RRC connection re-establishment procedure. During fast MCG link recovery, the UE suspends MCG transmissions for all radio bearers and reports the failure with MCG Failure Information message to the MN via the SCG, using the SCG leg of split Signaling Radio Bearer (SRB)1 or SRB3.

The UE includes in the MCG Failure Information message the measurement results available according to current measurement configuration of both the MN and the Secondary Node (SN). Once the fast MCG link recovery is triggered, the UE maintains the current measurement configurations from both the MN and the SN, and continues measurements based on configuration from the MN and the SN, if possible. The UE initiates the RRC connection re-establishment procedure if it does not receive an RRC reconfiguration message or RRC release message within a certain time (determined by a timer called T316) after fast MCG link recovery was initiated.

Upon reception of the MCG Failure Indication, the MN can send RRC reconfiguration message or RRC release message to the UE, using the SCG leg of split SRB1 or SRB3. Upon receiving an RRC reconfiguration message, the UE resumes MCG transmissions for all radio bearers. Upon receiving an RRC release message, the UE releases all the radio bearers and configurations.

### SUMMARY

As discussed above, in LTE/NR rel-16, the MCG fast recovery procedure is being specified such that a UE, instead of initiating a re-establishment procedure when the UE detects an RLF with respect to an MCG, the UE sends an MCG failure information report to the MN using the SCG leg of split SRB1 or SRB3. That is, no RLF report will be generated/stored by the UE. Thus, when fast MCG failure recovery is being employed by the UE, it is possible for the UE to experience several radio link failures but not report any one of them. The downside of this is that valuable information will be lost that could have been used by the self-organizing network (SON) and/or minimization of drive tests (MDT) mechanisms in the network to identify possible coverage holes or other problems (e.g., areas of high interference) or incorrect/sub-optimal handover/mobility parameter settings (e.g. handover offsets/thresholds).

This disclosure describes, among other things, methods executed by a UE for reporting radio link failure (RLF) related information. In one embodiment, in the case where the UE detects an RLF with respect to an MCG and the UE is configured to perform the fast MCG failure recovery procedure in response to the UE detecting the RLF with respect to the MCG, the UE generates and stores an RLF report regardless of the fact that the fast MCG failure recovery is configured for the UE. The UE can maintain a list of multiple RLF reports at once. Additionally (or alternatively), in the case where the UE detects an RLF with respect to an MCG and the UE is configured to implement the fast MCG failure recovery procedure, the UE transmits to the network “enhanced” MCG failure information that includes information (e.g. UE location) that is not included in the conventional MCG failure information but which could be as useful to the network as an RLF report. In the embodiments where the UE generates and stores the RLF report, the UE may add the report to a list of prior reports if a timer (e.g., T316) expires after the UE transmits the MCG failure information. If the UE receives an RRC message in response to transmitting the MCG failure information but before the timer expires, the UE may transmit an RRC response message that includes information indicating that the UE has one or more RLF reports available.

According to some embodiments, there is provided a method for providing radio link failure (RLF) information. The method comprises a user equipment (UE) detecting an RLF with respect to a master cell group, MCG. The method further comprises in response to detecting the RLF with respect to the MCG, the UE storing an RLF report and initiating a fast MCG link recovery procedure.

According to some embodiments, there is provided a method for providing radio link failure (RLF) information. The method comprises a user equipment (UE) detecting an RLF with respect to a master cell group (MCG). The method further comprises in response to detecting the RLF with respect to the MCG, the UE transmitting to a secondary node master cell group (MCG) failure information. The MCG failure information may comprise at least one of, timing information indicating a time at which the RLF was detected on the MCG, location information indicating the location of the UE at the time that the radio link failure was detected on the MCG, UE mobility information (e.g. horizontal speed), a list of EPLMNs (equivalent PLMNs) stored by the UE, measurement results that are not part of legacy MCG failure information (e.g. measurements on UTRAN, GRAN, WLAN, CDMA, Bluetooth), a tracking area code of the failed PCell and the source PCell, a C-RNTI used by the previous source PCell, a global cell identity of the failed PCell and the source PCell, or random-access related information (e.g., chronological order in which different beams were accessed, whether the accessed beams were above/below the thresholdSSB/thresholdCSI-RS, whether the contention was detected in each random-access attempt etc).

According to some embodiments, there is provided a method performed by a network function. The method comprises the network function providing configuration information to a user equipment (UE). The configuration may comprise master cell group (MCG) failure recovery configuration information for configuring the UE to initiate a fast MCG link recovery procedure in response to the UE detecting an MCG link failure. The configuration may also comprise radio link failure (RLF) configuration information for configuring the UE to generate and store an RLF report in response to the UE detecting the MCG link failure.

According to some embodiments, there is provided a method performed by a network function. The method comprises the network function receiving from a user equipment (UE) master cell group (MCG) failure information that was transmitted by the UE as a result of the UE detecting a radio link failure with respect to the MCG. The MCG failure information may comprise at least one of timing information indicating a time at which the RLF was detected, location information indicating the location of the UE at the time that the radio link failure was detected, UE mobility information (e.g. horizontal speed), a list of EPLMNs (equivalent PLMNs) stored by the UE, measurement results that are not part of legacy MCG failure information (e.g. measurements on UTRAN, GRAN, WLAN, CDMA, Bluetooth), a tracking area code of the failed PCell and the source PCell, a C-RNTI used by the previous source PCell, a global cell identity of the failed PCell and the source PCell, or random-access related information (e.g., chronological order in which different beams were accessed, whether the accessed beams were above/below the thresholdSSB/thresholdCSI-RS, whether the contention was detected in each random-access attempt etc).

According to some embodiments, there is provided a method performed by a network function. The method comprises the network function transmitting to a user equipment (UE) a radio resource control (RRC) message. The method further comprises the network function receiving an RRC response message transmitted by the UE in response to the RRC message transmitted to the UE. The RRC response message may comprise information indicating that the UE has stored one or more radio link failure (RLF) reports.

In another aspect there is provided a computer program comprising instructions which, when executed on at least one processor, cause the at least one processor to carry out any one of the methods disclosed herein. In another aspect there is provide a carrier containing the computer program, wherein the carrier is one of an electronic signal, optical signal, radio signal, or computer readable storage medium.

An advantage of the embodiments disclosed herein is that important RLF reports that could be used for proper optimization of the network will not be lost. Additionally, if the MN had initiated a handover just prior to the MCG RLF declaration by the UE, then it is unclear to the network whether the UE declared RLF after receiving the handover command (too early handover or handover to wrong cell) or before receiving the handover command (too late handover) as the network is unaware of the failedCell of the MCG RLF.

### BRIEF DESCRIPTION OF THE DRAWINGS

The accompanying drawings, which are incorporated herein and form part of the specification, illustrate various embodiments.

FIG. 1 shows an exemplary 5G RAN (NG-RAN) architecture.

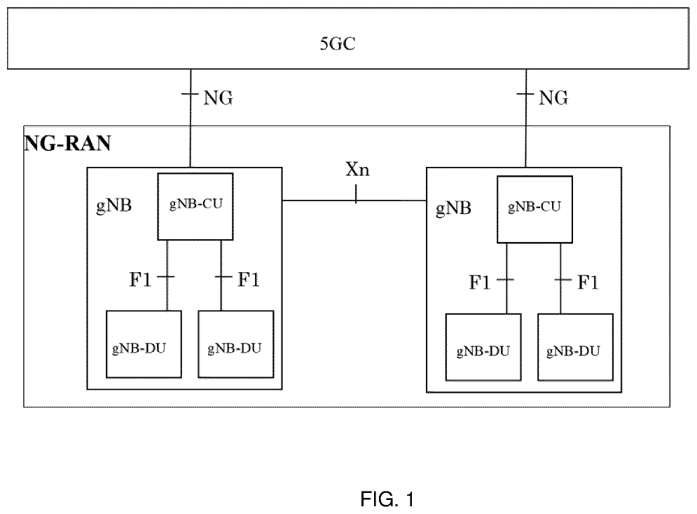

FIG. 2 shows higher layer RLF related procedures in LTE.

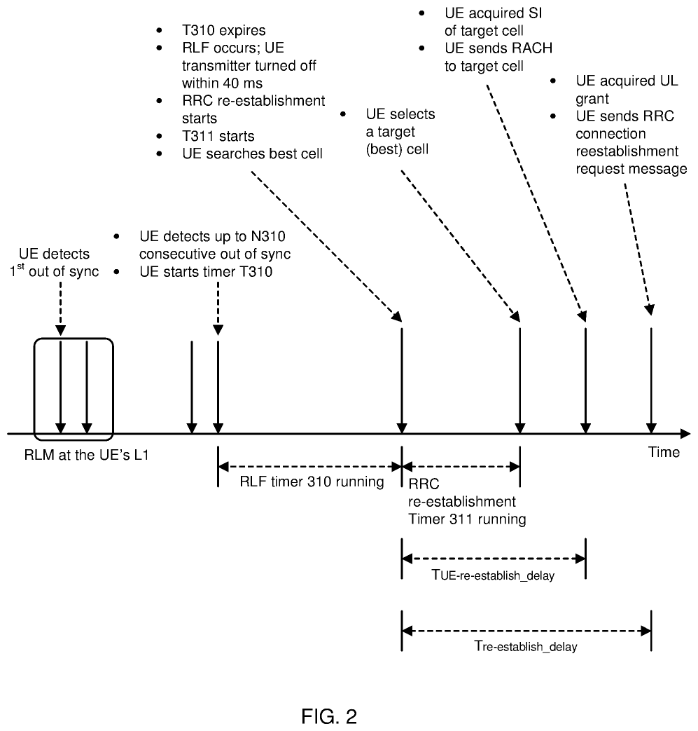

FIG. 3 is a message flow diagram according to some embodiments.

FIG. 4 is a process according to some embodiments.

FIG. 5 is a process according to some embodiments.

FIG. 6 is a process according to some embodiments.

FIG. 7 is a process according to some embodiments.

FIG. 8 is a process according to some embodiments.

FIG. 9 shows a UE according to some embodiments.

FIG. 10 shows an apparatus according to some embodiments.

### DETAILED DESCRIPTION

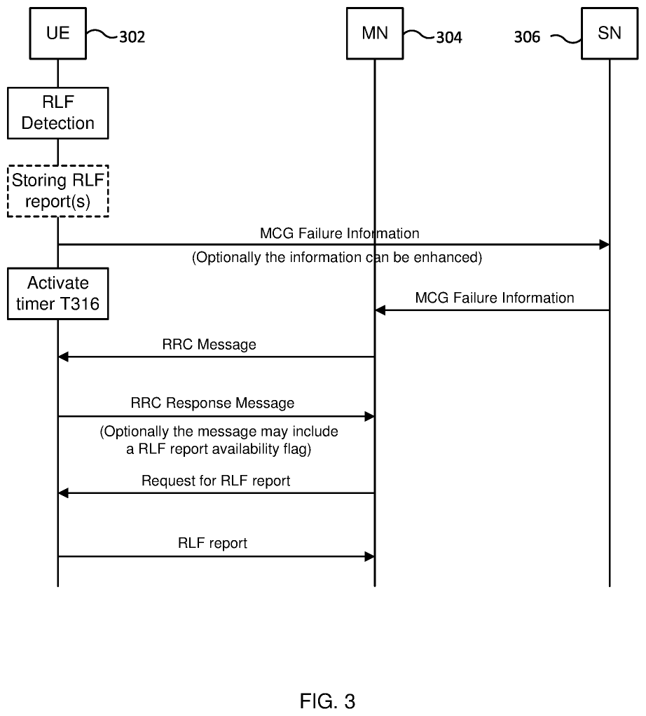

FIG. 3 is a message flow diagram illustrating various embodiments of this disclosure. As shown in FIG. 3, UE 302 detects a radio link failure (RLF) (e.g. due to physical layer problem, random access problem, reaching maximum number of RLF retransmissions) for a link between the UE and a master node 304.

In at least one embodiment, in response to detecting the RLF, the UE generates and stores a RLF report regardless of whether not fast MCG failure recovery is configured.

In response to detecting the RLF, UE also initiates a fast MCG link recovery procedure (this assumes that the UE is configured for MCG failure recovery). Initiating the fast MCG link recovery procedure comprises the UE 302 transmitting MCG failure information to the MN 304 via a secondary node (SN) 306. For example, the MCG failure information is transmitted to the SN 306 using the SCG leg of split SRB1 or SRB3. Additionally, if the UE has no radio link failure reports stored, the UE initializes a radio link failure report list (with zero entries) and adds the generated radio link failure report as one element to the radio link failure report list. In one embodiment, an indication is included in this entry to indicate that the RLF report was generated while MCG failure recovery was available. The RRC format that is used to encode the RLF report could be based on the MN (in both intra-RAT and inter-RAT DC cases). Some fields of the RLF report (e.g., failed PCell identity) could be included both within the RLF report and also directly in the message (MCG failure information) to aid the SN's forwarding of the RLF report message to the MN.

In another embodiment, initiating the fast MCG link recovery procedure comprises the UE 302 transmitting enhanced MCG failure information to the MN 304 via a secondary node (SN) 306. For example, the enhanced MCG failure information is transmitted to the SN 306 using the SCG leg of split SRB1 or SRB3. The enhanced MCG failure information contains: timing information indicating a time at which the RLF was detected; location information indicating the location of the UE at the time that the radio link failure was detected; UE mobility information (e.g. horizontal speed); a list of EPLMNs (equivalent PLMNs) stored by the UE; measurement results that are not part of legacy MCG failure information (e.g. measurements on UTRAN, GRAN, WLAN, CDMA, Bluetooth); a tracking area code of the failed PCell and the source PCell; a C-RNTI used by the previous source PCell; a global cell identity of the failed PCell and the source PCell; and/or random-access related information (e.g., chronological order in which different beams were accessed, whether the accessed beams were above/below the thresholdSSB/thresholdCSI-RS, whether the contention was detected in each random-access attempt etc).

After SN 306 receives the MCG failure information SN 306 transmits at least part of the MCG failure information to MN 304. In one embodiments, the MCG failure information comprises information that enables SN 306 to obtain the network address of MN 304 so that SN 306 can send the MCG failure information to MN 304.

When UE 302 transmits the MCG failure information UE 302 starts a timer (e.g., T316) which is set to expire after a predetermined amount of time.

If UE 302 receives an RRC message (e.g., RRC Reconfiguration or Release message) from the network before the timer expires, then UE 302 may send an RRC response message (e.g., RRCReconfigurationComplete, RRCReestablismentComplete, RRCResumeComplete, RRCSetupComplete) that contains information indicating that UE 302 has at least one RLF report stored.

If the timer expires before UE 302 receives the RCC message, then UE 302 keeps storing the list of RLF reports and the UE will add a report to the list the next time a RLF is detected. In some embodiments, however, the list has a maximum size of 1 report such that each report is “overwritten” when a new report is generated and stored. The next time UE 302 sends an RRC response message, the response message may indicate that the UE 302 has at least one RLF report stored. That is, when sending subsequent RRC response messages (e.g. RRCReconfigurationComplete, RRCReestablismentComplete, RRCResumeComplete, RRCSetupComplete, etc), indicating that an RLF report is available (e.g. including the rlf-InfoAvailable IEs in these messages).

In one embodiment, the UE also includes additional information in the RRC response message such as the number of RLF reports that are stored by the UE, how many of these reports are “real” RLF reports (i.e. not generated while MCG failure recovery was not available), etc.

As shown in FIG. 3, after UE 302 transmits the RRC response message, the UE 302 may receive a request from the network to send the RLF report(s) (e.g. UEInformationRequest message with the rlf-ReportReq IE included). In response, the request, UE 302 transmits one or more of its stored RLF reports to the requestor. In one embodiment, the network can indicate how many entries (e.g. n) from the list the UE should send (this could be indicated either in the UEInformationRequest or sparely, for example, in previous RRC Reconfiguration messages, or indicated in system information). In one embodiment, the number of entries that can be included in one report can be specified in a 3GPP standard. In one embodiment, the UE implicitly determines how many entries it can fit depending on the radio resource grants that it has received for sending the reports. It can also be left up to UE implementation on how many reports the UE can include (e.g. based on UE battery, current connection speed, other active bearers, etc.). If there are more RLF report than the can be sent by the UE at once (based on one of the above), the UE could determine the subset of entries based on, for example: the age of the RLF reports (e.g. the oldest n entries, the newest n entries); the size of the RLF reports are (e.g. start including the RLF reports from the report with the smallest size in ascending order until all the space available by the grant is used, start from the report with the largest size in descending order until the grant is used, etc. . . . ).

The above embodiments can be combined. For example, the UE generates the RLF report on RLF detection while MCG failure recovery is available, but it will treat it as normal RLF report. That is, as in legacy, it will keep it until it sends it via UEInformationResponse or the validity time for RLF (which is currently 48 hrs in 3gpp specifications) has passed. If another RLF occurs (and at that time the MCG failure recovery may or not be available) before that happens (i.e. RLF report not sent and 48 hrs has not passed), the UE will delete the previous RLF report and replaces it with the new one.

### Network Embodiments

In one embodiment a network function is provided that provides configuration information to UE 302. In one embodiment, the configuration information includes information that indicates: whether the UE applies fast MCG failure recovery or not; whether the UE could generate RLF reports when detecting RLF while fast MCG link recovery is available; how many RLF reports can the UE maintain at one time; the configuration for the contents to be included in the RLF report when the MCG link recovery is available vs when it is not available. The configuration information may also include parameters used by the UE to determine whether a radio link failure has occurred (e.g. due to physical layer problem, random access problem, reaching maximum number of RLF retransmissions).

In one embodiment a network function is provided that receives an MCG failure information or enhanced MCG failure information from the UE. In case of receiving enhanced MCG failure information, the network function identifies the network node in which the failure occurred and then passes the enhanced MCG failure information to the network node or function that is responsible for SON/MRO/MDT. This information is further forwarded from the CU (centralized unit housing the RRC functionality) to the DU (distributed unit housing the RLC,MAC,PHY functionality) of the network node in which the failure occurred and also the source network node of the handover that resulted in the failure.

In another embodiment, a network function is provided that receives from the UE information specifying that the UE has one or more RLF reports (e.g. via an RRC Reconfiguration Complete, RRC Re-establishment Complete, RRC Resume Complete RRC Setup Complete). The indication from the UE could contain additional info such as how many RLF reports the UE has, the size of the RLF reports, etc. After receiving this RLF report information from the UE, the network function may send a request to the UE to send the RLF report (s) (e.g. in UEInformationRequest message), which could include additional information such as how many reports the UE should send. As shown in FIG. 3, after sending such a request, the network function may receive one or more RLF report(s) transmitted by the UE (e.g. via UEINformationResponse).

Example of list of RLF reports.

VarRLF-Report—The UE variable VarRLF-Report includes the radio link failure information or handover failure information.

VarRLF-Report UE variable

```
-- ASN1START
-- TAG-VARRLF-REPORT-START
VarRLF-Report-r16 ::=  SEQUENCE {
    rlf-ReportList-r16  RLF-ReportList-r16,
    plmn-Identity-r16  PLMN-IdentityList-r16
}
-- TAG-VARRLF-REPORT-STOP
-- ASN1STOP
RLF-ReportList-r16 ::= SEQUENCE (SIZE (1..maxRLFReport)) OF RLF-Report-r16
RLF-Report-r16 ::=  SEQUENCE {
    measResultLastServCell-r16  MeasResultRLFNR-r16,
    measResultNeighCells-r16  SEQUENCE {
        measResultListNR-r16  MeasResultList2NR-r16
    OPTIONAL,
        measResultListEUTRA-r16 MeasResultList2EUTRA-r16
    OPTIONAL
    } OPTIONAL,
    c-RNTI-r16  RNTI-Value,
    previousPCellId-r16  CGI-InfoNR OPTIONAL,
    failedPCellId-r16  CHOICE {
        cellGlobalId-r16  CGI-InfoNR,
        pci-arfcn-r16  SEQUENCE {
            physCellId-r16  PhysCellId,
            carrierFreq-r16  ARFCN-ValueNR
        }
    } OPTIONAL,
    reestablishmentCellId-r16  CGI-InfoNR OPTIONAL,
    timeConnFailure-r16  INTEGER (0..1023)  OPTIONAL,
    timeSinceFailure-r16  TimeSinceFailure-r16,
    connectionFailureType-r16  ENUMERATED {rlf, hof}  OPTIONAL,
    rlf-Cause-r16  ENUMERATED {
                                t310-Expiry, randomAccessProblem,
                                rlc-MaxNumRetx, beamFailureRecoveryFailure,
spared, spare3, spare2, spare1},
    locationInfo-r16  LocationInfo-r16  OPTIONAL,
    perRAInfoList-r16  PerRAInfoList-r16  OPTIONAL,
    fastMCGFailureRecovery Available ENUMERATED {true} OPTIONAL
}
```

Example of enhanced MCG failure information (applicable for NR-DC wherein NR RRC format is used to send these additional information).

MCGFailureInformation

The MCGFailureInformation message is used to provide information regarding NR MCG failures detected by the UE. The Signalling radio bearer is SRB1, the RLC-SAP is A c, the Logical channel is DCCH, and the direction is UE to Network

The table below illustrates an example MCGFailureInformation message

```
-- ASN1START
-- TAG-MCGFAILUREINFORMATION-START
MCGFailureInformation-r16 ::=  SEQUENCE {
  criticalExtensions  CHOICE {
    mcgFailureInformation-r16  MCGFailureInformation-r16-IEs,
    criticalExtensionsFuture  SEQUENCE { }
  }
}
MCGFailureInformation-r16-IEs ::=  SEQUENCE {
  failureReportMCG-r16  FailureReportMCG-r16 OPTIONAL,
  nonCriticalExtension  SEQUENCE { }  OPTIONAL
}
FailureReportMCG-r16 ::=  SEQUENCE {
  failureType-r16  ENUMERATED {
                            t310-Expiry, randomAccessProblem,
                            rlc-MaxNumRetx, beamFailureRecoveryFailure, T312-
expiry,spare,spare,spare},
  measResultFreqList-r16 MeasResultList2NR
OPTIONAL,
  measResultF reqListEUTRA-r16 MeasResultList2EUTRA
OPTIONAL,
  measResultSCG-r16 OCTET STRING (CONTAINING
MeasResultSCG-Failure) OPTIONAL,
  measResultSCG-EUTRA-r16 OCTET STRING
OPTIONAL,
  ...,
    locationInfo-r16  LocationInfo-r16  OPTIONAL,
    previousPCellId-r16  CGI-InfoNR  OPTIONAL,
    failedPCellId-r16  CHOICE {
      cellGlobalId-r16  CGI-InfoNR,
      pci-arfcn-r16  SEQUENCE {
        physCellId-r16  physCellId,
        carrierFreq-r16  RFCN-ValueNR
    } OPTIONAL,
  }
  timeConnFailure-r16  INTEGER (0..1023) OPTIONAL,
  timeSinceFailure-r16  TimeSinceFailure-r16,
  connectionFailureType-r16  ENUMERATED {rlf, hof} OPTIONAL,
  perRAInfoList-r16  PerRAInfoList-r16 OPTIONAL
}
MeasResultList2EUTRA ::=  SEQUENCE (SIZE
(1..maxNrofServingCellsEUTRA)) OF MeasResult2EUTRA
-- TAG-MCGFAILUREINFORMATION-STOP
-- ASN1STOP
```

Storing of conditional handover failure information for one or multiple attempted conditional handover target cells in the UE. The UE indicating the existence of the report to the network, the network requesting the report and the UE sending the report. The network forwarding the report to the original source cell and possibly the attempted target cells.

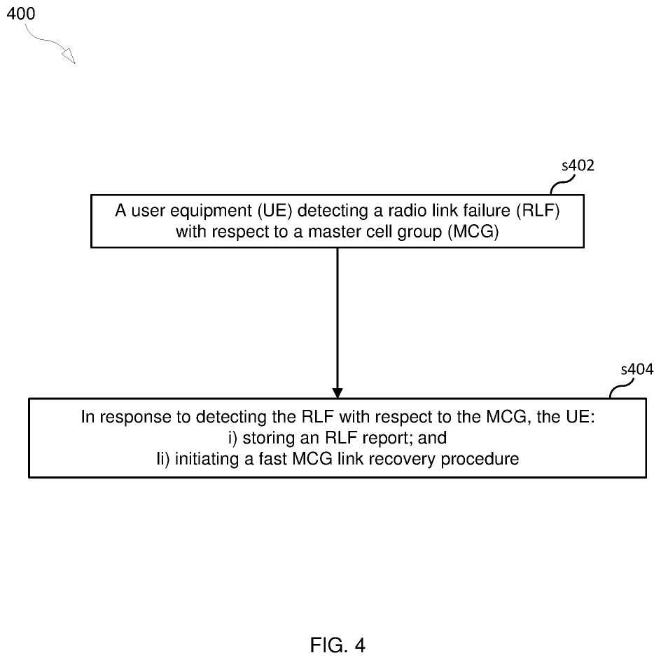

FIG. 4 is a flow chart illustrating a process 400 for providing radio link failure (RLF) information. The process 400 may begin with step s402.

Step s402 comprises a user equipment (UE) detecting an RLF with respect to a master cell group (MCG).

Step s404 comprises in response to detecting the RLF with respect to the MCG, the UE storing an RLF report and initiating a fast MCG link recovery procedure.

In some embodiments, initiating the fast MCG link recovery procedure comprises the UE transmitting to a secondary node (SN) MCG failure information.

In some embodiments, the MCG failure information comprises at least one of timing information indicating a time at which the RLF was detected, location information indicating the location of the UE at the time that the radio link failure was detected, UE mobility information (e.g. horizontal speed), a list of EPLMNs (equivalent PLMNs) stored by the UE, measurement results that are not part of legacy MCG failure information (e.g. measurements on UTRAN, GRAN, WLAN, CDMA, Bluetooth), a tracking area code of the failed PCell and the source PCell, a C-RNTI used by the previous source PCell, a global cell identity of the failed PCell and the source PCell, or random-access related information (e.g., chronological order in which different beams were accessed, whether the accessed beams were above/below the thresholdSSB/thresholdCSI-RS, whether the contention was detected in each random-access attempt etc).

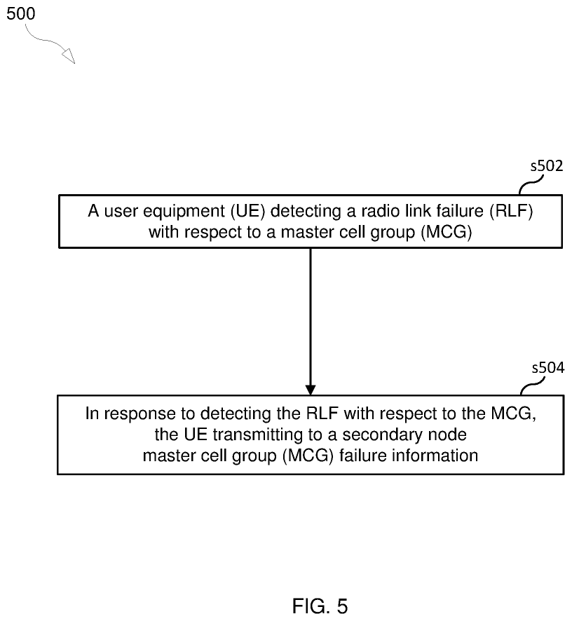

FIG. 5 is a flow chart illustrating a process 500 for providing radio link failure (RLF) information. The process 500 may begin with step s502.

Step s502 comprises a user equipment (UE) detecting an RLF with respect to a master node (MN).

Step s504 comprises in response to detecting the RLF with respect to the MN, the UE transmitting to a secondary node master cell group (MCG) failure information.

In some embodiments, the MCG failure information comprises at least one of timing information indicating a time at which the RLF was detected, location information indicating the location of the UE at the time that the radio link failure was detected, UE mobility information (e.g. horizontal speed), a list of EPLMNs (equivalent PLMNs) stored by the UE, measurement results that are not part of legacy MCG failure information (e.g. measurements on UTRAN, GRAN, WLAN, CDMA, Bluetooth), a tracking area code of the failed PCell and the source PCell, a C-RNTI used by the previous source PCell, a global cell identity of the failed PCell and the source PCell, or random-access related information (e.g., chronological order in which different beams were accessed, whether the accessed beams were above/below the thresholdSSB/thresholdCSI-RS, whether the contention was detected in each random-access attempt etc).

In some embodiments, the process 500 further comprises storing a RLF report in response to detecting the RLF with respect to the MN.

In some embodiments, the process 500 further comprises detecting the expiration of a timer (e.g., T316) and as a result of detecting the expiration of the timer, adding the RLF report to a list of RLF reports.

In some embodiments, the process 500 further comprises the UE transmitting a message comprising information indicating that the UE has stored one or more RLF reports.

In some embodiments, the process 500 further comprises prior to the expiration of a timer (e.g., T316), receiving a radio resource control (RRC) message (e.g., RRC Reconfiguration, RRC Reestablishment, RRC Resume). The message may comprise the information indicating that the UE has stored one or more RLF reports is transmitted in response to the RRC message.

In some embodiments, the message comprising the information indicating that the UE has stored one or more RLF reports is an RRC Reconfiguration Complete, an RRC Reestablishment Complete, or an RRC Resume Complete.

In some embodiments, the process 500 further comprises after transmitting the message comprising the information indicating that the UE has stored one or more RLF reports, receiving an RLF report request message and in response to the RLF report request message, the UE transmitting to the sender of the RLF report request message at least one of the one or more RLF reports.

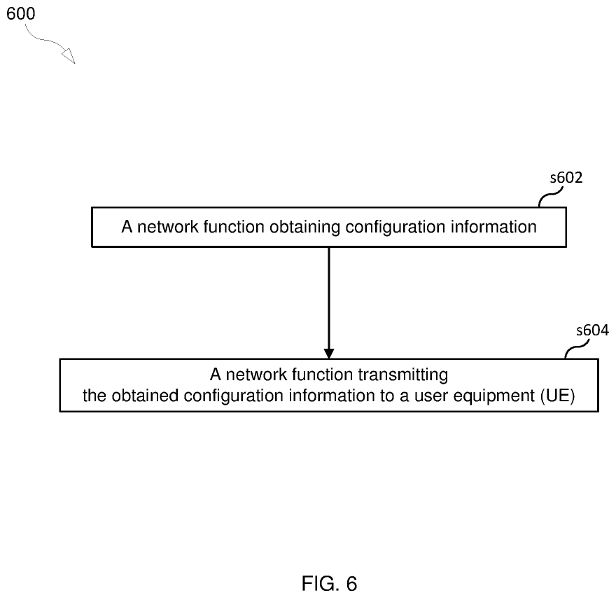

FIG. 6 is a flow chart illustrating a process 600 performed by a network function. The process 600 may begin with step s602.

Step s602 comprises the network function obtaining configuration information.

Step s604 comprises the network function transmitting the obtained configuration information to a user equipment (UE). The configuration information may comprise master cell group (MCG) failure recovery configuration information for configuring the UE to initiate a fast MCG link recovery procedure in response to the UE detecting an MCG link failure. The configuration information may also comprise radio link failure (RLF) configuration information for configuring the UE to generate and store an RLF report in response to the UE detecting the MCG link failure.

In some embodiments, the RLF configuration information further comprises information indicating a maximum number of RLF reports.

In some embodiments, the RLF configuration information further comprises information specifying the type of information to be included in an RLF report.

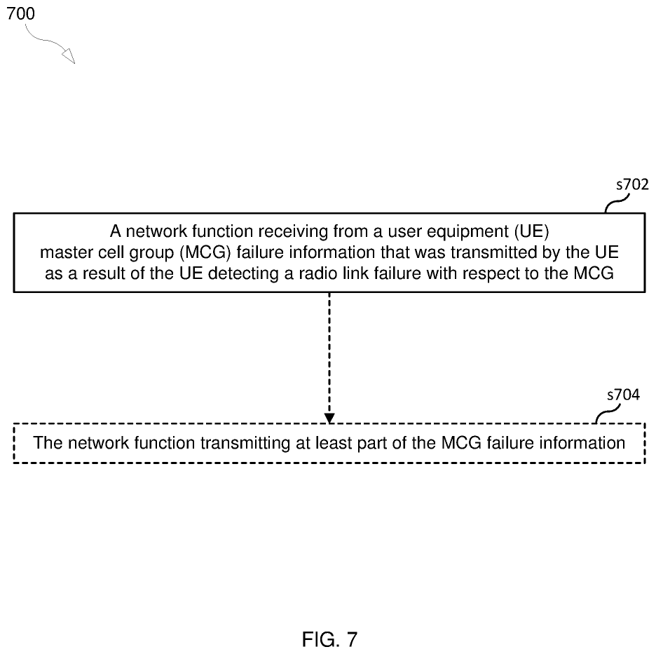

FIG. 7 is a flow chart illustrating a process 700 performed by a network function. The process 700 may begin with step s702.

Step s702 comprises the network function receiving from a user equipment (UE) master cell group (MCG) failure information that was transmitted by the UE as a result of the UE detecting a radio link failure with respect to the MCG. The MCG failure information may comprise at least one of timing information indicating a time at which the RLF was detected, location information indicating the location of the UE at the time that the radio link failure was detected, UE mobility information (e.g., horizontal speed), a list of EPLMNs (equivalent PLMNs) stored by the UE, measurement results that are not part of legacy MCG failure information (e.g. measurements on UTRAN, GRAN, WLAN, CDMA, Bluetooth), a tracking area code of the failed PCell and the source PCell, a C-RNTI used by the previous source PCell, a global cell identity of the failed PCell and the source PCell, or random-access related information (e.g., chronological order in which different beams were accessed, whether the accessed beams were above/below the thresholdSSB/thresholdCSI-RS, whether the contention was detected in each random-access attempt etc).

In some embodiments, the process 700 may further comprise identifying a network node to which the MCG failure information pertains and transmitting at least part of the MCG failure information to: i) the identified network node and/or ii) a control node. The transmission of at least part of the MCG failure information corresponds to the optional step s704 shown in FIG. 7.

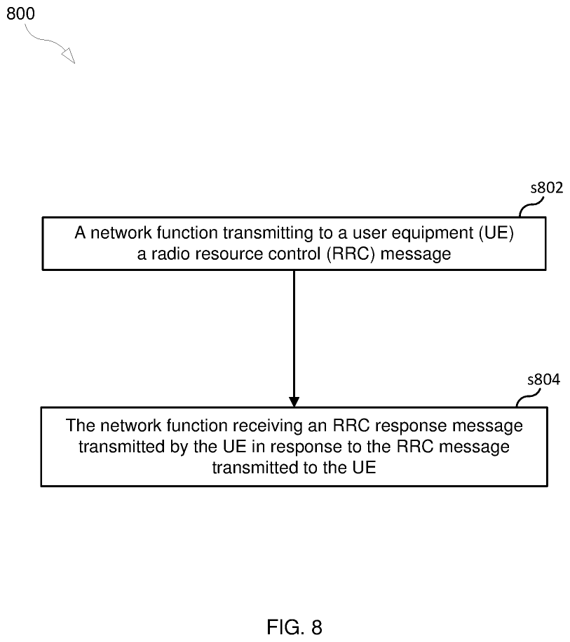

FIG. 8 is a flow chart illustrating a process 800 performed by a network function. The process 800 may begin with step s802.

Step s802 comprises the network function transmitting to a user equipment (UE) a radio resource control (RRC) message.

Step s804 comprises the network function receiving an RRC response message transmitted by the UE in response to the RRC message transmitted to the UE. The RRC response message may comprise information indicating that the UE has stored one or more radio link failure (RLF) reports.

In some embodiments, the process 800 may further comprise after receiving the RRC response message, transmitting to the UE an RLF report request message and after transmitting the RLF report request message, receiving at least one RLF report transmitted by the UE.

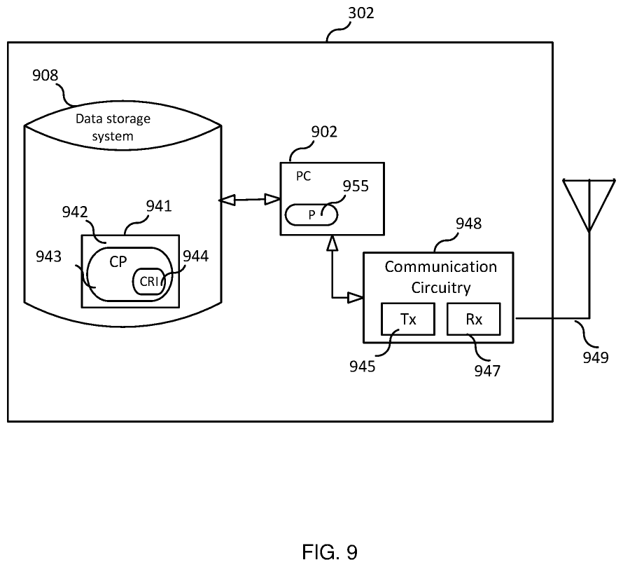

FIG. 9 is a block diagram of UE 302, according to some embodiments. As shown in FIG. 9, UE 302 may comprise: processing circuitry (PC) 902, which may include one or more processors (P) 955 (e.g., one or more general purpose microprocessors and/or one or more other processors, such as an application specific integrated circuit (ASIC), field-programmable gate arrays (FPGAs), and the like); communication circuitry 948, which is coupled to an antenna arrangement 949 comprising one or more antennas and which comprises a transmitter (Tx) 945 and a receiver (Rx) 947 for enabling UE 302 to transmit data and receive data (e.g., wirelessly transmit/receive data); and a local storage unit (a.k.a., “data storage system”) 908, which may include one or more non-volatile storage devices and/or one or more volatile storage devices. In embodiments where PC 902 includes a programmable processor, a computer program product (CPP) 941 may be provided. CPP 941 includes a computer readable medium (CRM) 942 storing a computer program (CP) 943 comprising computer readable instructions (CRI) 944. CRM 942 may be a non-transitory computer readable medium, such as, magnetic media (e.g., a hard disk), optical media, memory devices (e.g., random access memory, flash memory), and the like. In some embodiments, the CRI 944 of computer program 943 is configured such that when executed by PC 902, the CRI causes UE 302 to perform steps described herein (e.g., steps described herein with reference to the flow charts). In other embodiments, UE 302 may be configured to perform steps described herein without the need for code. That is, for example, PC 902 may consist merely of one or more ASICs. Hence, the features of the embodiments described herein may be implemented in hardware and/or software.

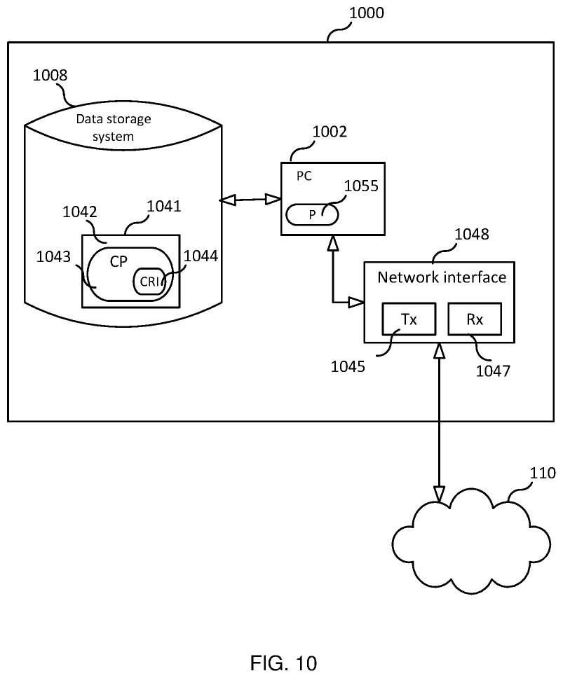

FIG. 10 is a block diagram of an apparatus 1000, according to some embodiments, for performing the network function methods disclosed herein. As shown in FIG. 10, apparatus 1000 may comprise: processing circuitry (PC) 1002, which may include one or more processors (P) 1055 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 1000 may be a distributed computing apparatus); at least one network interface 1048 comprising a transmitter (Tx) 1045 and a receiver (Rx) 1047 for enabling apparatus 1000 to transmit data to and receive data from other nodes connected to a network 110 (e.g., an Internet Protocol (IP) network) to which network interface 1048 is connected (directly or indirectly) (e.g., network interface 1048 may be wirelessly connected to the network 110, in which case network interface 1048 is connected to an antenna arrangement); and a storage unit (a.k.a., “data storage system”) 1008, which may include one or more non-volatile storage devices and/or one or more volatile storage devices. In embodiments where PC 1002 includes a programmable processor, a computer program product (CPP) 1041 may be provided. CPP 1041 includes a computer readable medium (CRM) 1042 storing a computer program (CP) 1043 comprising computer readable instructions (CRI) 1044. CRM 1042 may be a non-transitory computer readable medium, such as, magnetic media (e.g., a hard disk), optical media, memory devices (e.g., random access memory, flash memory), and the like. In some embodiments, the CRI 1044 of computer program 1043 is configured such that when executed by PC 1002, the CRI causes apparatus 1000 to perform steps described herein (e.g., steps described herein with reference to the flow charts). In other embodiments, apparatus 1000 may be configured to perform steps described herein without the need for code. That is, for example, PC 1002 may consist merely of one or more ASICs. Hence, the features of the embodiments described herein may be implemented in hardware and/or software.

### Summary of Various Embodiments

### UE—Embodiment A

A1. A method for providing radio link failure, RLF, information, the method comprising: a user equipment detecting an RLF with respect to a master cell group, MCG; and in response to detecting the RLF with respect to the MCG, the UE: i) storing an RLF report; and ii) initiating a fast MCG link recovery procedure.

A2. The method of embodiment A1, wherein initiating the fast MCG link recovery procedure comprises the UE transmitting to a secondary node, SN, master cell group, MCG, failure information.

A3. The method of embodiment A2, wherein the MCG failure information (or the RLF report) comprises at least one of: timing information indicating a time at which the RLF was detected, location information indicating the location of the UE at the time that the radio link failure was detected, UE mobility information (e.g. horizontal speed), a list of EPLMNs (equivalent PLMNs) stored by the UE, measurement results that are not part of legacy MCG failure information (e.g. measurements on UTRAN, GRAN, WLAN, CDMA, Bluetooth), a tracking area code of the failed PCell and the source PCell, a C-RNTI used by the previous source PCell, a global cell identity of the failed PCell and the source PCell, or random-access related information (e.g., chronological order in which different beams were accessed, whether the accessed beams were above/below the thresholdSSB/thresholdCSI-RS, whether the contention was detected in each random-access attempt etc).

### UE—Embodiment B

B1. A method for providing radio link failure, RLF, information, the method comprising: a user equipment detecting an RLF with respect to a master node (MN) (e.g., with respect to a master cell group (MCG)); and in response to detecting the RLF with respect to the MN, the UE transmitting to a secondary node MCG failure information that comprises at least one of: timing information indicating a time at which the RLF was detected, location information indicating the location of the UE at the time that the radio link failure was detected, UE mobility information (e.g. horizontal speed), a list of EPLMNs (equivalent PLMNs) stored by the UE, measurement results that are not part of legacy MCG failure information (e.g. measurements on UTRAN, GRAN, WLAN, CDMA, Bluetooth), a tracking area code of the failed PCell and the source PCell, a C-RNTI used by the previous source PCell, a global cell identity of the failed PCell and the source PCell, or random-access related information (e.g., chronological order in which different beams were accessed, whether the accessed beams were above/below the thresholdSSB/thresholdCSI-RS, whether the contention was detected in each random-access attempt etc).

B2. The method of embodiment B1, further comprising storing a RLF report in response to detecting the RLF with respect to the MN.

B3. The method of any one of embodiment A1-A3 or B2, further comprising: detecting the expiration of a timer (e.g. T316); and as a result of detecting the expiration of a timer, adding the RLF report to a list of RLF reports.

B4. The method of any one of embodiments A1-A3, B2, or B3, further comprising the UE transmitting a message comprising information indicating that the UE has stored one or more RLF reports.

B5. The method of embodiment B4, further comprising: prior to the expiration of a timer (e.g., T316), receiving a radio resource control, RRC, message (e.g., RRC Reconfiguration, RRC Reestablishment, RRC Resume), wherein the message comprising the information indicating that the UE has stored one or more RLF reports is transmitted in response to the RRC message.

B6. The method of embodiment B5, wherein the message comprising the information indicating that the UE has stored one or more RLF reports is an RRC Reconfiguration Complete, an RRC Reestablishment Complete, or an RRC Resume Complete.

B7. The method of any one of embodiments B4-B6, further comprising: after transmitting the message comprising the information indicating that the UE has stored one or more RLF reports, receiving an RLF report request message; and in response to the RLF report request message, the UE transmitting to the sender of the RLF report request message at least one of the one or more RLF reports.

B8. The method of any one of embodiments A1-A3 or B2-B7, wherein the RLF report comprises information indicating that the RLF report was generated while an MCG failure recovery was available.

B9. The method of any one of embodiments A1-A3 or B2-B7, wherein storing the RLF report comprises storing the RLF report such that the RLF report overwrites a previously store RLF report.

B10. The method of any one of embodiments A1-A3 or B1-7, further comprising the UE receiving configuration information transmitted by a network function (304, 306), the configuration information comprising MCG failure recovery configuration information for configuring the UE to initiate a fast MCG link recovery procedure in response to the UE detecting an MCG link failure.

### Network Embodiments

C1. A method performed by a network function, the method comprising: the network function providing configuration information to a user equipment, wherein the configuration information comprises: MCG failure recovery configuration information for configuring the UE to initiate a fast MCG link recovery procedure in response to the UE detecting an MCG link failure.

C2. The method of embodiment C1, wherein the configuration information further comprises radio link failure, RLF, configuration information for configuring the UE to generate and store an RLF report in response to the UE detecting the MCG link failure.

C3. The method of embodiment C2, wherein the RLF configuration information further comprises information indicating a maximum number of RLF reports.

C4. The method of embodiment C2 or C3, wherein the RLF configuration information further comprises information specifying the type of information to be included in an RLF report.

D1. A method performed by a network function, the method comprising: the network function receiving from a user equipment, UE, master cell group, MCG, failure information that was transmitted by the UE as a result of the UE detecting a radio link failure with respect to the MCG, wherein the MCG failure information comprises at least one of: timing information indicating a time at which the RLF was detected, location information indicating the location of the UE at the time that the radio link failure was detected, UE mobility information (e.g. horizontal speed), a list of EPLMNs (equivalent PLMNs) stored by the UE, measurement results that are not part of legacy MCG failure information (e.g. measurements on UTRAN, GRAN, WLAN, CDMA, Bluetooth), a tracking area code of the failed PCell and the source PCell, a C-RNTI used by the previous source PCell, a global cell identity of the failed PCell and the source PCell, or random-access related information (e.g., chronological order in which different beams were accessed, whether the accessed beams were above/below the thresholdSSB/thresholdCSI-RS, whether the contention was detected in each random-access attempt etc).

D2. The method of embodiment D1, further comprising identifying a network node to which the MCG failure information pertains and transmitting at least part of the MCG failure information to: i) the identified network node and/or ii) a control node.

E1. A method performed by a network function, the method comprising: the network function transmitting to a user equipment, UE, a radio resource control, RRC, message; and the network function receiving an RRC response message transmitted by the UE in response to the RRC message transmitted to the UE, wherein the RRC response message comprises information indicating that the UE has stored one or more radio link failure, RLF, reports.

E2. The method of embodiment E1, further comprising: after receiving the RRC response message, transmitting to the UE an RLF report request message; and after transmitting the RLF report request message, receiving at least one RLF report transmitted by the UE.

E3. The method of embodiment E1 or E2, further comprising receiving from the UE master cell group, MCG, failure information.

E4. The method of embodiment E2, receiving at least one RLF report comprises receiving at least a first RLF report, and the method further comprises identifying a network node to which the first RLF report pertains and transmitting at least part of the first RLF report to: i) the identified network node and/or ii) a control node.

F1. A UE (302) for providing radio link failure, RLF, information, the UE being adapted to: detect an RLF with respect to a master cell group, MCG; and in response to detecting the RLF with respect to the MC: i) store an RLF report; and ii) initiate a fast MCG link recovery procedure.

G1. A UE (302) for providing radio link failure, RLF, information, the UE being adapted to: detect an RLF with respect to a master node, MN; and in response to detecting the RLF with respect to the MN, transmit to a secondary node master cell group, MCG, failure information that comprises at least one of: timing information indicating a time at which the RLF was detected, location information indicating the location of the UE at the time that the radio link failure was detected, UE mobility information (e.g. horizontal speed), a list of EPLMNs (equivalent PLMNs) stored by the UE, measurement results that are not part of legacy MCG failure information (e.g. measurements on UTRAN, GRAN, WLAN, CDMA, Bluetooth), a tracking area code of the failed PCell and the source PCell, a C-RNTI used by the previous source PCell, a global cell identity of the failed PCell and the source PCell, or random-access related information (e.g., chronological order in which different beams were accessed, whether the accessed beams were above/below the thresholdSSB/thresholdCSI-RS, whether the contention was detected in each random-access attempt etc).

G2. The UE of embodiment F1 or G1, wherein the UE is further configured to perform the method of any one of embodiments A2-A3 or B2-B7.

H1. An apparatus (1000), the apparatus being adapted to: provide configuration information to a user equipment, wherein the configuration information comprises: MCG failure recovery configuration information for configuring the UE to initiate a fast MCG link recovery procedure in response to the UE detecting an MCG link failure, and radio link failure, RLF, configuration information for configuring the UE to generate and store an RLF report in response to the UE detecting the MCG link failure.

H2. The apparatus of embodiment H1, wherein the apparatus is further configured to perform the method of any one of embodiments C2-C3.

I1. An apparatus (1000), the apparatus being adapted to: receive from a user equipment, UE, master cell group, MCG, failure information that was transmitted by the UE as a result of the UE detecting a radio link failure with respect to the MCG, wherein the MCG failure information comprises at least one of: timing information indicating a time at which the RLF was detected, location information indicating the location of the UE at the time that the radio link failure was detected, UE mobility information (e.g. horizontal speed), a list of EPLMNs (equivalent PLMNs) stored by the UE, measurement results that are not part of legacy MCG failure information (e.g. measurements on UTRAN, GRAN, WLAN, CDMA, Bluetooth), a tracking area code of the failed PCell and the source PCell, a C-RNTI used by the previous source PCell, a global cell identity of the failed PCell and the source PCell, or random-access related information (e.g., chronological order in which different beams were accessed, whether the accessed beams were above/below the thresholdSSB/thresholdCSI-RS, whether the contention was detected in each random-access attempt etc).

I2. The apparatus of embodiment I1, wherein the apparatus is further configured to perform the method of embodiment D2.

J1. An apparatus (1000), the apparatus being adapted to: transmit to a user equipment, UE, a radio resource control, RRC, message; and receive an RRC response message transmitted by the UE in response to the RRC message transmitted to the UE, wherein the RRC response message comprises information indicating that the UE has stored one or more radio link failure, RLF, reports.

J2. The apparatus of embodiment J1, wherein the apparatus is further configured to perform the method of any one of embodiment E2.

K1. A computer program comprising instructions which when executed by processing circuitry causes the processing circuitry to perform the method of any one of embodiments A1-E2

K2. A carrier containing the computer program of embodiment K1, wherein the carrier is one of an electronic signal, an optical signal, a radio signal, and a computer readable storage medium.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1-35. (canceled)

36. A method for providing radio link failure (RLF) information, the method comprising:
a user equipment (UE) detecting an RLF with respect to a master cell group (MCG); and
in response to detecting the RLF with respect to the MCG, the UE: i) storing an RLF report; and ii) initiating a fast MCG link recovery procedure;
wherein initiating the fast MCG link recovery comprises sending an MCG failure information message to the Master Node (MN) via the Secondary Cell Group (SCG) upon the detection of the radio link failure on the MCG, instead of triggering radio resource control (RRC) re-establishment.

37. The method of claim 36, wherein the RLF report comprises at least one of:
timing information indicating a time at which the RLF with respect to the master cell group was detected,
location information indicating the location of the UE at the time that the RLF with respect to the master cell group was detected,
UE mobility information,
a list of equivalent PLMNs (EPLMNs) stored by the UE,
measurement results that are not part of legacy MCG failure information,
a tracking area code of the failed PCell and the source PCell,
a C-RNTI used by the previous source PCell,
a global cell identity of the failed PCell and the source PCell, or
random-access related information.

38. The method of claim 36, wherein:
the master cell group (MCG) failure information comprises at least one of:
timing information indicating a time at which the RLF with respect to the MCG was detected,
location information indicating the location of the UE at the time that the radio link failure with respect to the MCG was detected,
UE mobility information,
a list of equivalent PLMNs, EPLMNs, stored by the UE,
measurement results that are not part of legacy MCG failure information,
a tracking area code of the failed PCell and the source PCell,
a C-RNTI used by the previous source PCell,
a global cell identity of the failed PCell and the source PCell, or
random-access related information.

39. The method of claim 38, further comprising storing a RLF report in response to detecting the RLF with respect to the MCG.

40. The method of claim 39, further comprising:
detecting the expiration of a timer; and
as a result of detecting the expiration of a timer, adding the RLF report to a list of RLF reports.

41. The method of claim 39, further comprising the UE transmitting a message comprising information indicating that the UE has stored one or more RLF reports.

42. The method of claim 41, further comprising: prior to the expiration of a timer, receiving a radio resource control (RRC) message, wherein
the step of the UE transmitting the message comprising the information indicating that the UE has stored one or more RLF reports comprises the UE transmitting said message in response to the RRC message.

43. The method of claim 41, wherein the message comprising the information indicating that the UE has stored one or more RLF reports is an RRC Reconfiguration Complete, an RRC Reestablishment Complete, or an RRC Resume Complete.

44. The method of claim 41, further comprising:
after transmitting the message comprising the information indicating that the UE has stored one or more RLF reports, receiving an RLF report request message; and
in response to the RLF report request message, the UE transmitting to the sender of the RLF report request message at least one of the one or more RLF reports.

45. The method of claim 36, wherein the RLF report comprises information indicating that the RLF report was generated while an MCG failure recovery was available.

46. The method of claim 36, wherein storing the RLF report comprises storing the RLF report such that the RLF report overwrites a previously stored RLF report.

47. The method of claim 36, further comprising the UE receiving configuration information transmitted by a network function, the configuration information comprising MCG failure recovery configuration information for configuring the UE to initiate a fast MCG link recovery procedure in response to the UE detecting an MCG link failure.

48. A method performed by a network function, the method comprising:
the network function providing configuration information to a user equipment (UE), wherein the configuration information comprises:
MCG failure recovery configuration information for configuring the UE to initiate a fast MCG link recovery procedure in response to the UE detecting an MCG link failure.

49. The method of claim 48, wherein the configuration information further comprises:
radio link failure (RLF) configuration information for configuring the UE to generate and store an RLF report in response to the UE detecting the MCG link failure.

50. The method of claim 49, wherein the RLF configuration information comprises information indicating a maximum number of RLF reports.

51. The method of claim 49, wherein the RLF configuration information further comprises information specifying the type of information to be included in an RLF report.

52. the method of claim 48, further comprising:
the network function receiving from a user equipment (UE) master cell group (MCG) failure information that was transmitted by the UE as a result of the UE detecting a radio link failure with respect to the MCG, wherein the MCG failure information comprises at least one of:
timing information indicating a time at which the RLF with respect to the MCG was detected,
location information indicating the location of the UE at the time that the radio link failure with respect to the MCG was detected,
UE mobility information,
a list of equivalent PLMNs, EPLMNs, stored by the UE,
measurement results that are not part of legacy MCG failure information,
a tracking area code of the failed PCell and the source PCell,
a C-RNTI used by the previous source PCell,
a global cell identity of the failed PCell and the source PCell, or
random-access related information.

53. The method of claim 48, further comprising identifying a network node to which the MCG failure information pertains and transmitting at least part of the MCG failure information to: i) the identified network node and/or ii) a control node.

54. A method performed by a network function, the method comprising:
the network function transmitting to a user equipment (UE) a radio resource control (RRC) message; and
the network function receiving an RRC response message transmitted by the UE in response to the RRC message transmitted to the UE, wherein the RRC response message comprises information indicating that the UE has stored one or more radio link failure (RLF) reports.

55. The method of claim 54, further comprising:
after receiving the RRC response message, transmitting to the UE an RLF report request message; and
after transmitting the RLF report request message, receiving at least one RLF report transmitted by the UE.

56. A user equipment (UE) for providing radio link failure (RLF) information, the UE being configured to:
detect an RLF with respect to a master cell group (MCG); and
in response to detecting the RLF with respect to the MCG: i) store an RLF report; and ii) initiate a fast MCG link recovery procedure;
wherein initiating the fast MCG link recovery comprises sending an MCG failure information message to the Master Node (MN) via the Secondary Cell Group (SCG) upon the detection of the radio link failure on the MCG, instead of triggering RRC re-establishment.

57. The user equipment, UE of claim 56, wherein:
the master cell group (MCG) failure information comprises at least one of:
timing information indicating a time at which the RLF was detected,
location information indicating the location of the UE at the time that the radio link failure was detected,
UE mobility information,
a list of equivalent PLMNs, EPLMNs, stored by the UE,
measurement results that are not part of legacy MCG failure information,
a tracking area code of the failed PCell and the source PCell,
a C-RNTI used by the previous source PCell,
a global cell identity of the failed PCell and the source PCell, or
random-access related information.

58. An apparatus, the apparatus being configured to:
provide configuration information to a user equipment, wherein the configuration information comprises: MCG failure recovery configuration information for configuring the UE to initiate a fast MCG link recovery procedure in response to the UE detecting an MCG link failure.

69. The apparatus of claim 58, wherein the configuration information further comprises radio link failure (RLF) configuration information for configuring the UE to generate and store an RLF report in response to the UE detecting the MCG link failure.

60. The apparatus of claim 58, further being configured to:
receive from a user equipment (UE) master cell group (MCG) failure information that was transmitted by the UE as a result of the UE detecting a radio link failure with respect to the MCG, wherein the MCG failure information comprises at least one of:
timing information indicating a time at which the RLF was detected,
location information indicating the location of the UE at the time that the radio link failure was detected,
UE mobility information,
a list of equivalent PLMNs (EPLMNs) stored by the UE,
measurement results that are not part of legacy MCG failure information,
a tracking area code of the failed PCell and the source PCell,
a C-RNTI used by the previous source PCell,
a global cell identity of the failed PCell and the source PCell, or
random-access related information.

61. The apparatus of claim 60, wherein the apparatus is further configured to:
identify a network node to which the MCG failure information pertains; and
transmit at least part of the MCG failure information to: i) the identified network node and/or ii) a control node.

62. An apparatus, the apparatus being configured to:
transmit to a user equipment (UE) a radio resource control (RRC) message; and
receive an RRC response message transmitted by the UE in response to the RRC message transmitted to the UE, wherein the RRC response message comprises information indicating that the UE has stored one or more radio link failure (RLF) reports.

63. The apparatus of claim 62, wherein the apparatus is further configured to:
after receiving the RRC response message, transmit to the UE an RLF report request message; and
after transmitting the RLF report request message, receive at least one RLF report transmitted by the UE.
